(19) United States
(12) Patent Application Publication
(10) Pub. No.: US 2011/0093349 A1
(43) Pub. Date: Apr. 21, 2011

(54) SYSTEM AND METHOD FOR PROVIDING LOCATION BASED OFFERS

(75) Inventors: Susan Drescher, Marietta, GA (US); Lani Mathis, Sandy Springs, GA (US); Michael Ayers, Sandy Springs, GA (US); Brian Dean, Baldwin, GA (US); Donald Synstelien, Marietta, GA (US)

(73) Assignee: extrafeet, inc., Marietta, GA (US)

(21) Appl. No.: 12/908,251

(22) Filed: Oct. 20, 2010

Related U.S. Application Data
(60) Provisional application No. 61/253,218, filed on Oct. 20, 2009.

(51) Int. Cl. G06Q 30/00

(52) U.S. Cl. 705/14.73; 705/1.1; 705/14.4

(57) ABSTRACT

The exemplary embodiments of the present invention provide a method and computer program products for providing an offer in a specific location. The method is embodied in a computer program product for execution on an instruction processing system and includes a tangible storage medium readable by the instruction processing system and storing instructions for execution by the instruction processing system for performing the method. The method further includes determining at least one offer to be sent to a user device, sending the at least one offer to user device and receiving information regarding the completion of the at least one offer. The method further includes verifying the user completed a task associated with the at least one offer and providing a benefit to an owner of the user device.

### CROSS-REFERENCE TO RELATED APPLICATIONS

This application claims the benefit of U.S. Provisional Patent Application 61/253,218, filed on Oct. 20, 2009, entitled “A System And Method For Providing A Location Based Offer Network”, which is incorporated by reference herein in its entirety.

### FIELD OF THE INVENTION

The present invention generally relates to a method and system for providing an advertisement, and more particularly, relates to a method and system for providing an offer or advertisement in a specific location.

### BACKGROUND

Currently, there are various forms of advertising networks on the Internet whereby visitors to a certain site are presented with offers or tasks to complete on behalf of an advertiser. Users who complete these tasks or offers will usually be presented with a reward or virtual payment of some sort in return for completion of the offers. These systems are commonly referred to as “Offer networks” and function by allowing third party application developers to present their users with advertiser offers tied to certain tasks within their application.

The limitations of these offer networks is that they are functional only inside the confines of a traditional online model, i.e. users can only complete offers while using the computer and advertisers can only drive visitors to participate in programs that exist virtually or require some online task.

There are also various forms of advertising networks on mobile devices where the systems present advertisements while the user is visiting a certain location. An example might be the presentation of an advertisement or coupon for company “A” when the owner of the mobile phone is visiting a location of company “A” or visiting a location of competing company “B”. These systems are commonly referred to as location based ad networks “LBAN” and function by giving third party mobile application developers tools to include a way to present these ads to users of their applications.

The limitation of these location based ad networks is that they require the mobile device be open and functioning at a certain location in order to present the advertisement effectively. This greatly limits the number of people who might see such an advertisement.

There is no mobile system that connects advertiser offers in a way similar to online offer networks (rewarding the user of the mobile phone for visiting a physical address or taking some other physical action) and leverages the existing traditional advertising strategies of presenting advertising to a mobile user while that user is at a certain location.

Thus, heretofore an unaddressed need exists in the industry to address the aforementioned deficiencies

### BRIEF SUMMARY

Embodiments of the present invention provide a method and computer program products for providing an offer in a specific location.

An exemplary embodiment includes a method for providing an offer in a specific location. The method is embodied in a computer program product for execution on an instruction processing system and includes a tangible storage medium readable by the instruction processing system and storing instructions for execution by the instruction processing system for performing the method. The method includes determining at least one offer to be sent to a user device, sending the at least one offer to user device and receiving information regarding the completion of the at least one offer. The method further includes verifying the user completed a task associated with the at least one offer and providing a benefit to an owner of the user device.

A further exemplary embodiment includes a computer program product for providing an offer in a specific location. The computer program product includes a tangible storage medium readable by a computer system and storing instructions or execution by the computer system for performing a method. The method includes determining at least one offer to be sent to a user device, sending the at least one offer to user device and receiving information regarding the completion of the at least one offer. The method further includes verifying the user completed a task associated with the at least one offer and providing a benefit to an owner of the user device.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings.

FIG. 1 is a block diagram illustrating an example of an environment of computer systems and the remote devices utilizing the webpage creation using media data system of the present invention.

FIG. 2A is a block diagram illustrating an example of a server utilizing the location based offer network system of the present invention, as shown in FIG. 1.

FIG. 2B is a block diagram illustrating an example of a remote device accessing the location based offer network system of the present invention, as shown in FIGS. 1 and 2A.

FIG. 3 is a flow chart illustrating an example of the operation of the location based offer network system of the present invention on the server, as shown in FIGS. 1 and 2A.

FIG. 4 is a flow chart illustrating an example of the operation of the get offers process utilized by the location based offer network system of the present invention on the server, as shown in FIGS. 1, 2A and 3.

FIG. 5 is a flow chart illustrating an example of the operation of the process offers process utilized by the location based offer network system of the present invention on the server, as shown in FIGS. 1, 2A and 3.

FIG. 6 is a flow chart illustrating an example of the operation of the verify user completed task process utilized by the location based offer network system of the present invention on the server, as shown in FIGS. 1, 2A and 5.

FIG. 7 is a flow chart illustrating an example of the operation of the remote device when interacting with the location based offer network system of the present invention, as shown in FIGS. 1, 2A and 5.

The detailed description explains the preferred embodiments of the invention, together with advantages and features, by way of example with reference to the drawings.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

One or more exemplary embodiments of the invention are described below in detail. The disclosed embodiments are intended to be illustrative only since numerous modifications and variations therein will be apparent to those of ordinary skill in the art.

The present invention to be described hereafter is applicable on all remote devices connected to a server hosting location based offer/advertisement network (LBON) in the present invention. While described below with respect to a single computer, the system and method for a LBON system is typically implemented in a networked computing environment in which a number of computing devices communicate over a local area network (LAN), a personal area network (PAN), a campus area network (CAN), a metropolitan area network (MAN), a wide area network (WAN) or a combination of any of the above. The LBON provides that connection. In one embodiment, users of mobile devices are presented with offers from the LBON system will be given incentives to visit a physical location or perform a task offline that is tied directly to an advertiser's physical location.

Users do not have to be present at any particular location to receive an offer, but rather are presented offers that inform them of rewards that they can receive/achieve if they visit one or more specified location(s). The specified location(s) can change over time as directed by the advertiser or interested party. Offers include task(s) to be presented to a user by the system on behalf of an advertiser or other interested party, A reward or token that is to be given to a person or thing upon successful completion of the task and a combination of elements that make up the task and the reward or token as mentioned in this document but not limited to those mentions.

The locations that the user is being given incentives to visit may be very near to or very far from the current location of the user of that mobile device and the incentive may be presented based on any number of individual or multiple factors, potentially including, but not limited to one or more of the following; demographics, psychographics, physical proximity to the location the reward is based, other activity performed in the past by that user, activities that known friends or associates of the user have taken or completed, purchased information, qualifying data entered by the user in the current application or in other applications and/or databases to name just a few.

Users may also be presented with incentives based on conditions at or near the user of the mobile device, potentially including but not limited to such things as weather at the location, population demographics at the location or other aspects of the location at or nearby the offer or the user of the mobile device, proximity of other users of mobile devices who might have access to our system, proximity of locations occupied by an advertiser, a competitor of the advertiser or a third party and/or the locations of services presented by an advertiser or a competitor or a third party.

The offer(s) may be tied to a location by means of a generic wireless position signal, that include for example, but are not limited to, any one or a combination of the following: GPS locator; Bluetooth; WiFi; cellular; optical, satellite; RF; Ethernet; magnetic induction; coax; RS-485; and/or other like networks; a physical plug; video, audio or other analog or digital signal input which can be either directed or ambient; infrared; supervisory input by a separate human being such as a person working at the location; or other means of determining location of the mobile device not limited to those available or known today.

In one embodiment the offer(s) are tied to a specified location(s). In another embodiment, the offer(s) are not tied to a specified location, but only require the user to complete a task and receive a reward including, for example, such as but not limited to; viewing of a video clip, completing a form or other task requiring input, performing a physical activity or entry of some form of data, such as a code or phrase word, comments, opinions, observations, or the like. The entry of data can be made by the user or be automatically received by other means.

Some incentives or rewards may be limited to be available or accessible only within or nearby the location(s) the user is being given incentives to visit, other incentives or rewards may be available at greater distances or through activity that must be completed on the mobile device with or without the requirement of the mobile device or user being present at a certain location.

Some rewards presented might require the completion of one or more task(s) at multiple locations or several tasks in one location or the completion of a single or multiple tasks alone regardless of location before any token or reward is delivered.

One example of the system might include, but not be limited to, presenting the user with the reward of “virtual currency” or other intangible, virtual object or objects inside a game or other application because they physically visited a specified location.

A second example of the LBON system or method might include for example, but not be limited to, the presentation to the user of one set of instructions or piece of content at nearly any location where the instructions instruct the user to visit a second location, and the presentation of a second set of instructions or piece of content at the second, targeted location. In this example, users at the first location may see a trailer to a film, or other entertainment or informative display to be presented by the users device or another device and users who visit the second location might see the whole film or other entertainment or informative display to be presented by the users device or another device.

In a third example, users might be presented with one or more options to unlock a hidden aspect to a game which could include but not be limited to such items as an extra level or hidden treasure. Discovering these items would only be possible while visiting a certain targeted physical location.

In a fourth example an application might include, but not be limited to, users playing a game on their mobile devices that rewards them with virtual currency or some other intangible reward if the game is played correctly. Those users may be given incentives to visit a physical location, such as, for example, a specified Las Vegas casino (or other location) and have the virtual currency or other intangible reward converted to casino chips or other real world items.

A fifth example might include, but not be limited to, a game which requires a mobile device for play requiring players to find, for example, an in-game item, virtual good or the like by visiting a specified physical location or by alternately or additionally completing a task at that specified physical location. Users who would seek the items in the game might not be able to find the item or virtual good or the like unless they were to visit the specified location. This aspect is similar to “geo caching” but instead of real world objects hidden at a set of geo-coordinates, the object to be found might be virtual in nature.

In a sixth example, a user of a game might have some in-game advantage by being located physically at a certain location, such an advantage might include for example, but not be limited to, extra defenses in a combat-oriented game or extra income in an investment oriented game.

A seventh example might include, but not be limited to, a user of an application being unable to access certain functions of a game while visiting a specific location. For example if a feature or aspect of an offer presented by the system or in an application is illegal in certain states or territories, users might not be presented with those features that are not legal.

An eighth example might be the rewarding of a coupon or other discount in conjunction with the users of an application who make a visit to the location. For example, a user visits a local coffee shop (or other store or location) and is rewarded with a coupon or discount for goods purchased on that or another visit.

In another embodiment, the LBON system or method contains the functionality to provide any or all of the following aspects; An application programming interface (API), software development kit (SDK or “devkit”) or other method or system of incorporation and/or a portal for application developers or advertisers to create and or populate and/or price rewards that can be connected to various locations and/or various advertisers by the system and/or by the developer and/or by the advertiser.

In another embodiment, the LBON system or method contains the functionality to provide any or all of the following aspects; An application programming interface (API), software development kit (SDK or “devkit”) or other method or system of incorporation and/or a portal for advertisers to create and or populate and/or price tasks that can be connected to various rewards and/or various developers by the system and/or by the developer and/or by the advertiser.

Such a system might operate autonomously, allowing developers to enter the required data and provide those aspects into the system in a self-serve manner. Such a system can instead or also require some form of review or approval before any offers are presented to the public mobile device users or to advertisers.

An API, SDK, other method or system of incorporation and/or a portal provides a way for developers to provide features in their applications that users can only access by visiting a physical location or performing a required task through means which can be tracked by the system and/or users of the system.

In another embodiment, the LBON system or method enables advertisers to automatically explore, bid on or otherwise purchase or secure a connection to rewards in the system.

In another embodiment, the LBON system or method operates in a self-serve manner, allowing advertisers to self price and self populate any purchases without any additional human interaction. Such a system can be placed on the internet or on networked servers and/or internet sites as appropriate.

In another embodiment, the LBON system or method automatically matches advertiser tasks to offers, developers, rewards, and/or applications based on criteria required by the system, by mobile device users, advertisers or developers using the system or by owners of the system.

Such criteria might include, but not be limited to, highest price, lowest price, most populated location nearby, least populated location nearby, traffic history of the system, of users of mobile devices and/or of traffic to or from any application or device. An API, SDK or product for entering and testing tasks and rewards prior to the offers being made public to users of mobile devices.

In another embodiment, the system could be used by owners of the system, and/or by advertisers and or others who might want to use the system. In one embodiment, an advertiser might have access to the system via an application on a mobile device similar to the ones that are served into by the system, providing a level of similarity for the devices that collect data and that receive offers. Such an application or device might capture unique aspects of the location and enter them automatically or allow the advertiser to enter them manually. Users of this application or mobile advertiser system might enter one or more of the following: a GPS location, and/or Bluetooth, WiFi, cellular, optical, satellite, RF, Ethernet, magnetic induction, coax, RS-485, and/or other like network or identifier, a physical plug, video, audio or other analog or digital signal input which can be either directed or ambient, supervisory input by a separate human being such as a person working at the location or other means of determining location of the mobile device not limited to those available or known today.

In an alternative embodiment, the LBON system or method provides a method for developers of applications to reward users of their applications when they meet criteria set forth by the system.

In an alternative embodiment, the LBON system or method provides for tracking and/or displaying the performance of such items as might include, but not be limited to, mobile device users or user-types, locations or location-types, offers or offer-types, offer content or offer content-types and/or other types of information which could be valuable to advertisers, developers, users of mobile devices or other individuals. Such a system might commonly be referred to as an analytics or metrics system and be utilized for at least, but not be limited to, the optimization of offers to enter, display, increase, decrease or otherwise modify to generate different performance as is commonly known in the art.

In the alternative embodiment, the LBON system or method enables users of mobile devices to petition the system and suggest corrections for locations, which have moved, disappeared, changed in some way or are otherwise inaccurately presented.

In still another alternative embodiment, the LBON system or method enables users of mobile devices to self-police inaccuracies presented by developers, applications made by developers and or advertisers or by the system itself in order to improve the overall effectiveness and or accuracy of the system.

In another alternative embodiment, the LBON system or method enables the over-riding of any and all offers in the system by the system owner in order to redirect the LBON system to perform some other function or set of functions as required. In another alternative embodiment, the LBON system enables being over-ridden and redirected to provide all offers in the system to a single advertiser or other purpose. In another alternative embodiment, the LBON system enables being over-ridden and redirected to provide one or more alert messages to notify the end user of the mobile device of an important message. In still another alternative embodiment, the LBON system enables being over-ridden and redirected to provide separate functionality based on a circumstance that may be in effect for the user of the mobile device, the application, the developer or the advertiser.

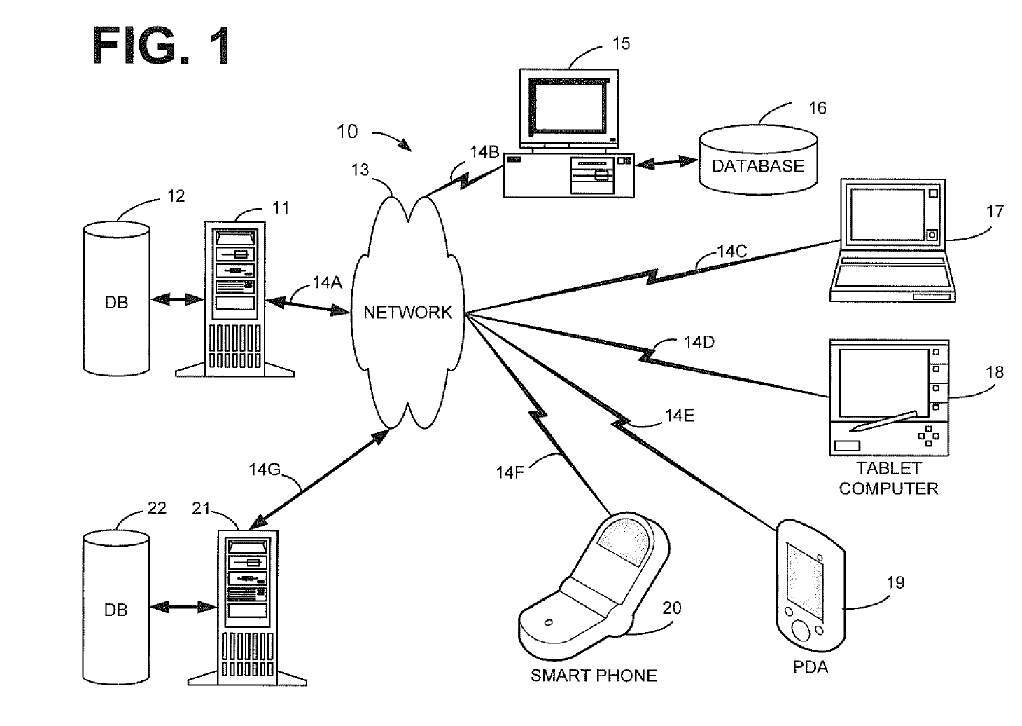

Referring now to the drawings, in which like numerals illustrate like elements throughout the several views, FIG. 1 is a block diagram illustrating an example of a location based offer network 10 environment including computer systems (11 and 21) and the remote devices (15, 17, 18, 19 and 20) that utilize the Location Based Offer Network system of the present invention.

Each remote device has applications and can have a local data store 16. Computer systems 11 and 21 contain applications, and server 11 further contains a server database 12 that is accessed by remote devices 15, and 17-20 via intermittent connections 14(A-F), respectively, over network 13. The server 11 runs administrative software for a computer network and controls access to part or all of the network and its devices. The remote devices 15 and 17-20 share the server data stored on the database 12 and may access the server 11 over a network 13 such as but not limited to; a local area network (LAN), a personal area network (PAN), a campus area network (CAN), a metropolitan area network (MAN), a wide area network (WAN) or a combination of any of the above. These networks may include but are not limited to the Internet, a telephone line using a modem (POTS), Bluetooth, WiFi, cellular, optical, satellite, RF, Ethernet, magnetic induction, coax, RS-485, and/or other like networks.

The structure and operation of the location based offer network enables the server 11 and the database 12 associated therewith to provide a location based offer network system that connects advertiser offers in a way similar to online offer networks (rewarding the user of the mobile phone for visiting a physical address or taking some other physical action) and leverages the existing traditional advertising strategies of presenting advertising to a mobile user while that user is at a certain location.

The remote devices 15 and 17-20 may each be mobility located at remote sites. Remote devices 15 and 17-20 include, but are not limited to; a PLC, PC, workstation, laptop, handheld computer, pocket PC, PDA, pager, WAP device, non-WAP device, cell phone, palm device, printing device and/or the like. Thus, when a user at one of the remote devices 15 and 17-20 desires to access the local offer or advertisement information on the data at the server 11, the remote devices 15 and 17-20 communicates over the network 13, such as but not limited to WAN, internet, or telephone lines to access the server 11.

Third party vendors' computer systems 21 and databases 22 can be accessed by the location based offer network server 11 in order to obtain information for dissemination to the remote devices 15 and 17-20. Data that is obtained from third party vendors computer system 21 and database 22 can be stored on the server 11 in order to provide later access to the remote devices 15 and 17-20. It is also contemplated that for certain types of data that the remote devices 15 and 17-20 can access the third-party vendor's data directly using the network 13.

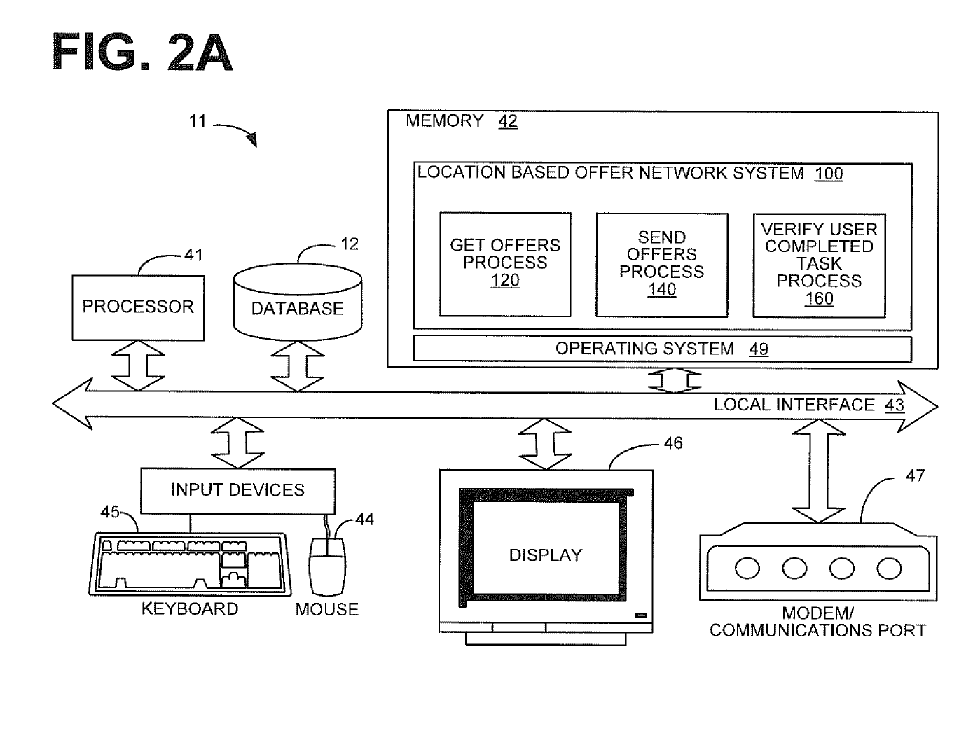

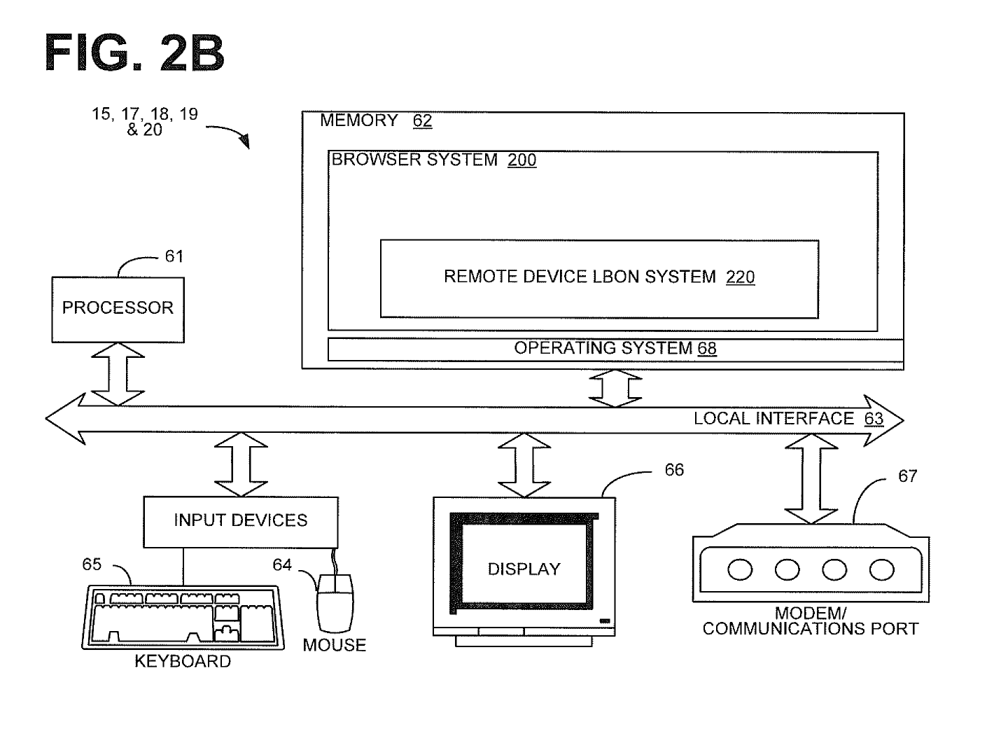

Illustrated in FIG. 2A is a block diagram demonstrating an example of a server 11, as shown in FIG. 1, utilizing the Location based offer network system 100 of the present invention. Remote devices 15 and 17-20 include but are not limited to, PCs, workstations, laptops, PDAs, pagers, WAP devices, non-WAP devices, cell phones, palm devices and the like. The components of the remote devices 15 and 17-20 are substantially similar to that of the description for the server 11 (FIG. 2A). However, it is contemplated that many of the components in the user's remote devices 15 and 17-20 can be more limited in general function.

Generally, in terms of hardware architecture, as shown in FIG. 2A, the server 11 includes a processor 41, memory 42, and one or more input and/or output (I/O) devices (or peripherals) that are communicatively coupled via a local interface 43. The local interface 43 can be, for example, one or more buses or other wired or wireless connections, as are known in the art. The local interface 43 may have additional elements, which are omitted for simplicity, such as controllers, buffers (caches), drivers, repeaters, and/or receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom-made or commercially available processor, a central processing unit (CPU), a data signal processor (DSP) or an auxiliary processor among several processors associated with the server 11, or a semiconductor-based microprocessor (in the form of a microchip) or a macroprocessor. Examples of suitable commercially available microprocessors include, but are not limited to, the following: an 80x86 or Pentium® series microprocessor from Intel® Corporation, U.S.A., a PowerPC® microprocessor from IBM®, U.S.A., a Sparc™ microprocessor from Sun Microsystems®, Inc., a PA-RISC™ series microprocessor from Hewlett-Packard Company®, U.S.A., a 68xxx series microprocessor from Motorola Corporation®, U.S.A. or a Phenom™, Athlon™, Sempron™ or Opteron™ microprocessor from Advanced Micro Devices®, U.S.A.

The memory 42 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and the location based offer network system 100 of the present invention. As illustrated, the location based offer network system 100 of the present invention comprises numerous functional components including, but not limited to, the get offers process 120, send offers process 140 and the verify user completed task process 160.

A non-exhaustive list of examples of suitable commercially available operating systems 49 is as follows (a) a Windows/Vista operating system available from Microsoft Corporation; (b) a Netware operating system available from Novell, Inc.; (c) a Macintosh/OS X operating system available from Apple Computer, Inc.; (d) an UNIX operating system, which is available for purchase from many vendors, such as but not limited to the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (such as for example Symbian OS available from Symbian, Inc., PalmOS available from Palm Computing, Inc., and Windows CE available from Microsoft Corporation).

The operating system 49 essentially controls the execution of other computer programs, such as the location based offer network system 100, and provides scheduling, input-output control, file and data management, memory management, and communication control and related services. However, it is contemplated by the inventors that the location based offer network system 100 of the present invention is applicable on all other commercially available operating systems.

The location based offer network system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the location based offer network system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, API, SDK, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote dispensing devices, other files, devices, systems, or a network), a radio frequency (RF) or other transceiver (not shown), a telephonic interface (not shown), a bridge (not shown), a router (not shown), and/or the like.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only memory, such as ROM, PROM, EPROM, EEPROM or the like, so that the BIOS can be executed when the server 11 is activated.

When the server 11 is in operation, the processor 41 is configured to execute software instructions stored within the memory 42, to communicate data to and from the memory 42, and generally to control operations of the server 11 pursuant to the software. The location based offer network system 100 and the O/S 49 instructions are read, in whole or in part, by the processor 41, perhaps buffered within the processor 41, and then executed.

When the location based offer network system 100 is implemented in software, as is shown in FIG. 2A, it should be noted that the location based offer network system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the location based offer network system 100 is implemented in hardware, the location based offer network system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote devices 15, and 17-20, that enables browser 200 and remote device LBON system 220 access to the location based offer network system 100 of the present invention, as shown in FIG. 2A. remote devices 15, and 17-20 provides access to the location based offer network system 100 of the present invention on server 11 and database 12 using the browser 200 on the remote devices 15 and remote device LBON system 220, including for example, but not limited to an Internet browser. The information accessed in server 11 and database 12 can be provided in the number of different forms including but not limited to ASCII data, WEB page data (i.e. HTML), XML or other type of formatted data.

As illustrated, the remote devices 15, and 17-20 are similar to the description of the components for server 11 described with regard to FIG. 2A. Hereinafter, the remote devices 15, and 17-20 that will be referred to as remote devices 15 for the sake of brevity.

The software in memory 62 may include one or more separate programs, each of which comprises an ordered listing of executable instructions for implementing logical functions. In the example illustrated in FIG. 2B, the software in the memory 62 includes a suitable operating system (O/S) 69 and the means on the remote device to access the location based offer network system 100 of the present invention. Hereinafter, the remote 15, and 17-20 will be referred to as the remote device 15 for the sake of brevity.

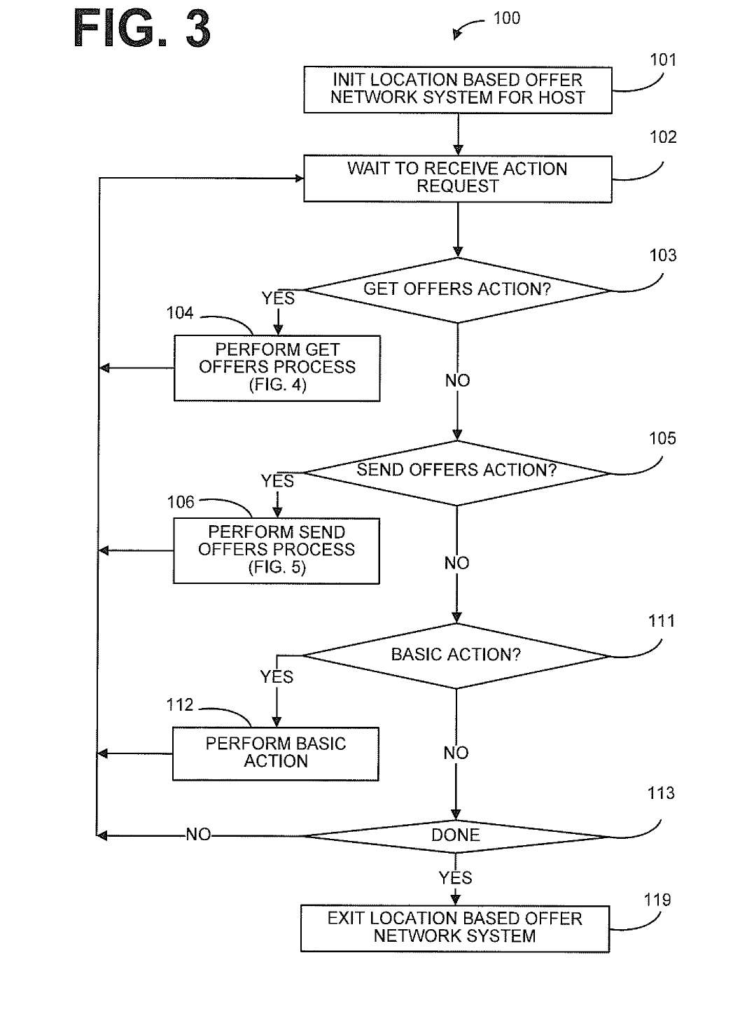

FIG. 3 is a flow chart illustrating an example of the operation of the location based offer network (LBON) system 100 of the present invention on the server, as shown in FIGS. 1 and 2A.

First at step 101, the location based offer network system 100 is initialized. This initialization includes a startup routines and processes embedded in the BIOS of the server 11. The initialization also includes the establishment of data values for particular data structures utilized in the server 11.

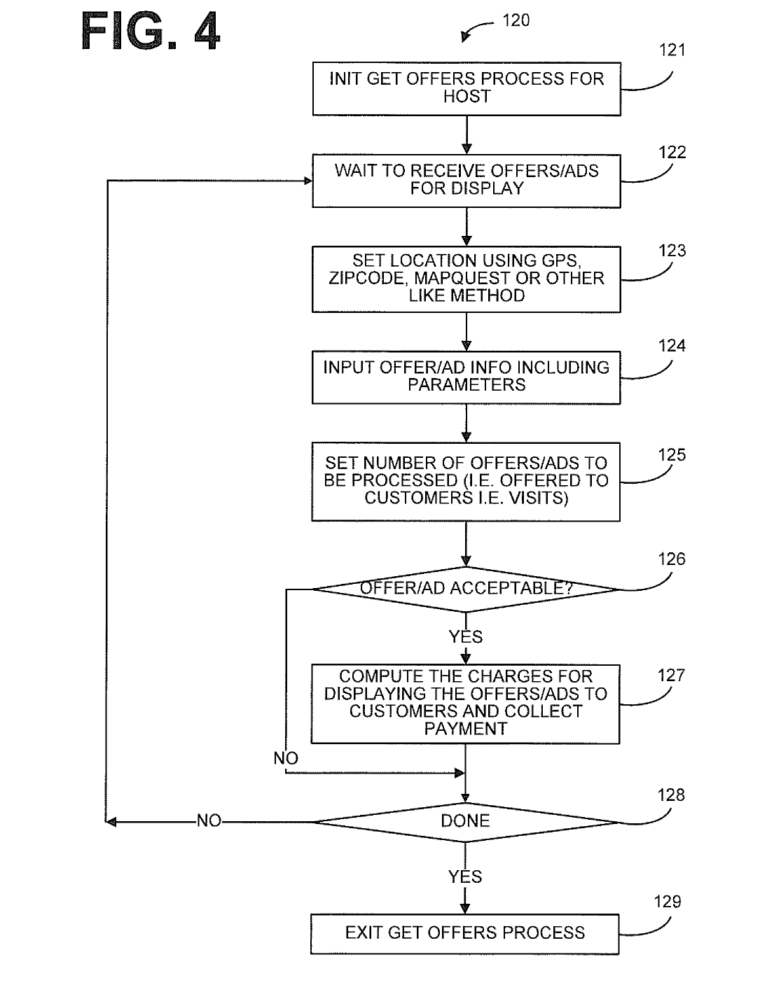

At step 102, the location based offer network system 100 waits to receive an action request. Once an action request is received at step 102, the LBON system 100 then determines if the action is a get offers action at step 103. If it is determined at step 103 that the action received is not a get offers action, then the LBON system 100 skips the step 105. However, if it is determined at step 103 that the action received is a get offers action, then the LBON system 100 performs the get offers process at step 104. The get offers process is herein defined in further detail in FIG. 4. After performing the get offers process, the LBON system 100 then returns to step 102 to wait to receive the next action request.

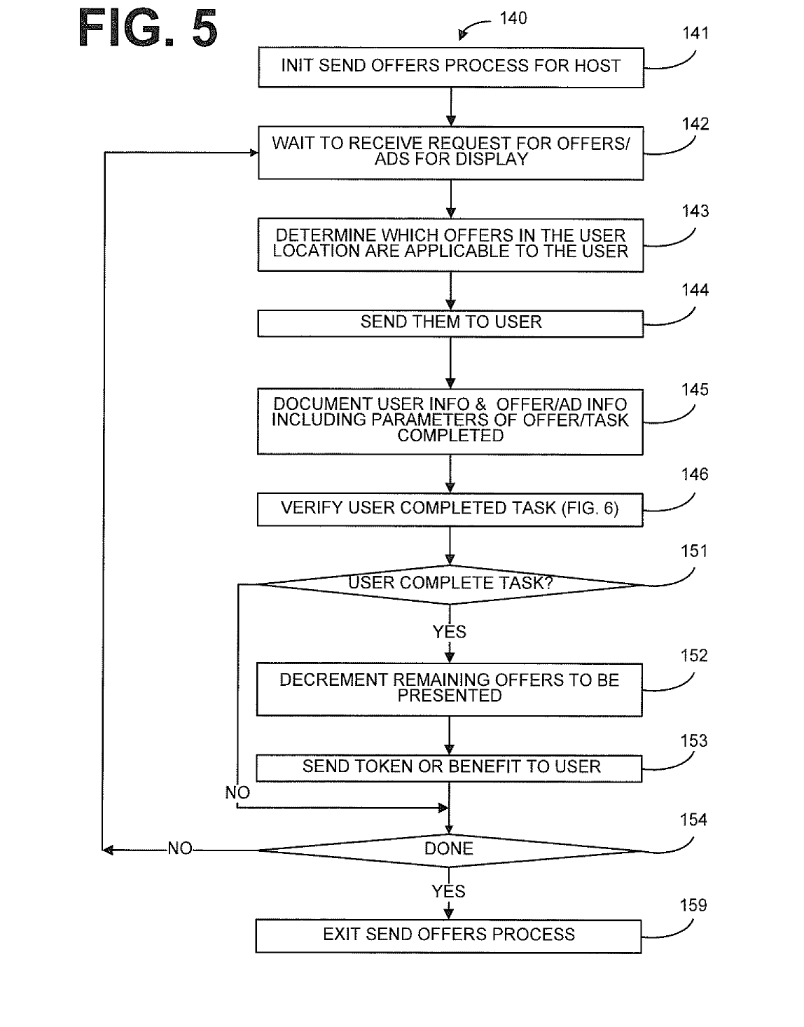

At step 105, the LBON system 100 determines if the action is a send offers action. If it is determined at step 105 that the action received is not a send offers action, then the LBON system 100 skips the step 111. However, if it is determined at step 105 that the action received is a send offers action, then the LBON system 100 performs the send offers process at step 106. The send offers process is herein defined in further detail in FIG. 5. After performing the send offers process, the LBON system 100 then returns to step 102 to wait to receive the next action request.

At step 111, the LBON system 100 determines if the action is a basic action to be performed. If it is determined at step 111 that the action received is not a basic action, then the LBON system 100 skips to step 113. However, if it is determined at step 111 that the action received is a basic action, then the LBON system 100 performs the basic action at step 112. After performing the basic action, the LBON system 100 then returns to step 102 to wait to receive the next action request.

At step 113, the LBON system 100 determines if there are more actions to be received. If it is determined in step 113 that there are more actions to be received, then the LBON system 100 returns to step 102 to wait to receive the next action request. However, if it is determined in step 113 that there are no more actions to be processed, then the LBON system 100 exits at step 119.

FIG. 4 is a flow chart illustrating an example of the operation of the get offers process 120 utilized by the location based offer network system 100 of the present invention on the server, as shown in FIGS. 1, 2A and 3. The get offers process 120 received information from retailers and vendors and utilizes that information to create and offer/add to be displayed to a user visiting or located in a specific location.

First at step 121, the get offers process 120 in the location based offer network system 100 is initialized. This initialization includes a startup routines and processes embedded in the BIOS of the server 11. The initialization also includes the establishment of data values for particular data structures utilized in the server 11.

At step 122, the get offers process 120 waits to receive an action request for creating an offer or advertisement for display. Once an action request is received at step 122, the get offers process 120 then receive the information regarding the location the offer that is to be displayed at 123. The location can be set using GPS, zip code, MapQuest or at there like method. At step 124, the get offers process 120 received the offer/advertisement information including parameters regarding actions or tasks to be performed. The parameters include information regarding the action or task to be performed in including the method to validate the action or task has been performed.

At step 125, the get offers process 120 allows the sender or retailer to set the number of offers/advertisements to be processed. This number of offers or adds to be process indicates the number of validated offers to customers that actually perform an action or task at the location specified.

At step 126, the get offers process 120 determines if the offer/ad is acceptable for inclusion in the LBON system 100. Certain parameters, including the number of displays, the content, and the actual verbiage of the ad/offer are compared to minimums requirements for accepting the offer. If it is determined in step 126 that the add/offer is not acceptable, then the get offers process 120 skips to step 128 to see if there are more ads/offers to be displayed.

However, if it is determined at step 126 that the ad/offers are acceptable, then the get offers process 120 computes the charges for the vendor or retailer for displaying the advertisements at step 127 using the set number of times indicated at step 125. The get offers process 120 then collects payment for displaying the offers/advertisements at step 127. The payment is collected using methods that are well known in the art, such as credit card, debit card, billing for the services and the like.

At step 128, the get offers process 120 determines if there are more actions to be received. If it is determined in step 128 that there are more actions to be received, then the get offers process 120 returns to step 122 to wait to receive the next action request. However, if it is determined in step 128 that there are no more actions to be processed, then the get offers process 120 exits at step 129.

FIG. 5 is a flow chart illustrating an example of the operation of the send offers process utilized by the location based offer network system 100 of the present invention on the server, as shown in FIGS. 1, 2A and 3. The send offers process 140 disseminates the information received from retailers and vendors to consumers located in a specific location.

First at step 141, the send offers process 140 in the location based offer network system 100 is initialized. This initialization includes a startup routines and processes embedded in the BIOS of the server 11. The initialization also includes the establishment of data values for particular data structures utilized in the server 11.

At step 142, the send offers process 140 waits to receive an action request for disseminating an offer or advertisement for display. Once an action request is received at step 142, the send offers process 140 then determines which offers in the user location are applicable to be user at step 143. The send offers process 140 then transmits those offers which are applicable to the user at that particular location at step 144. The location can be determined by using GPS, zip code, MapQuest or at there like method. At step 145, the send offers process 140 received information regarding the user and the selected offers/advertisement including parameters regarding actions or tasks to be performed. The parameters include information regarding the action or task to be performed in including the method to validate the action or task has been performed.

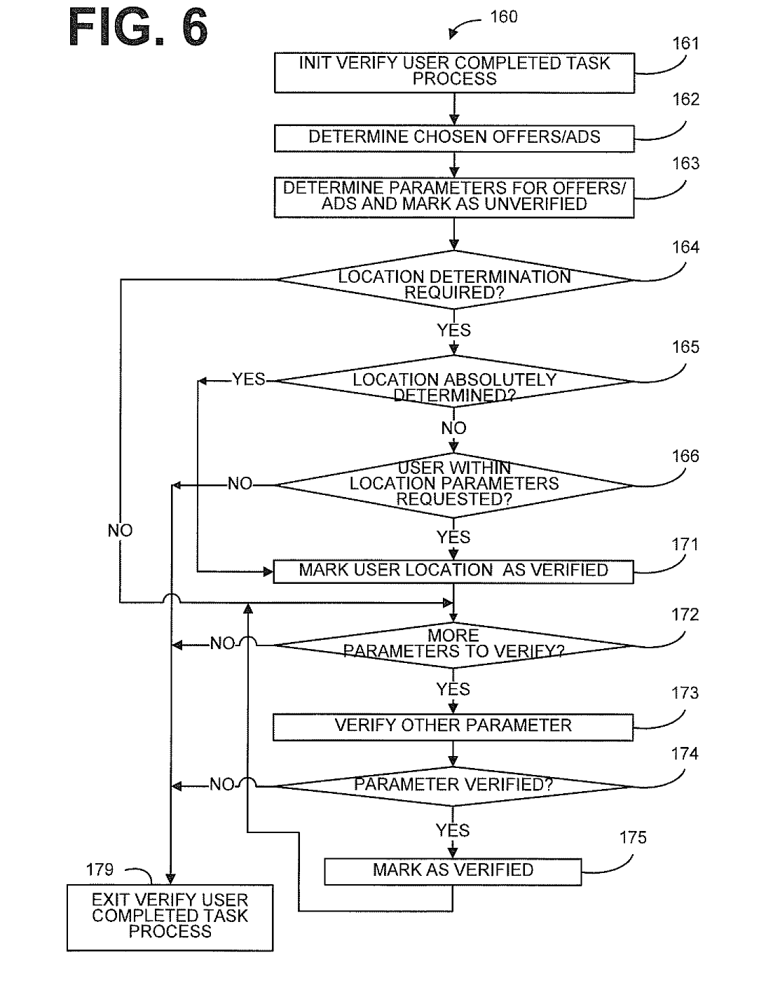

At step 146, the send offers process 140 verifies the user completed the required task. The process to verify that the user completed the required task is herein defined in further detail with regard to FIG. 6.

At step 151, the send offers process 140 checks to see if the user has completed the required task. If it is determined in step 151 that the user has not completed the required task to accept offers/add, then the send offers process 140 skips the step 154. However, if it is determined at step 151 that the user has completed the required task to receive the offer/ad, then the send offers process 140 reduces the number of remaining offers less advertisements to be presented to a user by one at step 152. This number of offers or ads to be process indicates the number of validated offers to customers that actually perform an action or task at the location specified by the a user. In an alternative embodiment, a time period for the advertisement is utilized instead of a predetermined number of advertisements or offers being presented. At step 153, the send offers process 140 sends a token or benefit to the user.

At step 154, the send offers process 140 determines if there are more actions to be received. If it is determined in step 154 that there are more actions to be received, then the send offers process 140 returns to step 142 to wait to receive the next action request. However, if it is determined in step 154 that there are no more actions to be processed, then the send offers process 140 exits at step 159.

FIG. 6 is a flow chart illustrating an example of the operation of the verify user completed task process 160 utilized by the location based offer network system 100 of the present invention on the server, as shown in FIGS. 1, 2A and 5. The verify user completed task process 160 verifies that the user has completed an offer or task parameter defined by the advertiser. This offer/task parameter may include but is not limited to verifying that the user visited a specific location, observed an advertisement (i.e. video/audio or some other image) or the like.

First at step 161, the verify user completed task process 160 in the location based offer network system 100 is initialized. This initialization includes a startup routines and processes embedded in the BIOS of the server 11. The initialization also includes the establishment of data values for particular data structures utilized in the server 11.

At step 162, the verify user completed task process 160 determines the offers/ads chosen by the user. After determining which offers/ads was chosen by the user, then the verify user completed task process 160 determines which parameters are to be verified for the offer/ads and mark these parameters as unverified.

At step 164, it is determined if a location determination for completing the offer/ad is required. If it is determined at step 164 that the location determination for completion of the offers/ad is not required, then the verify user completed task process 160 skips to step 172. However, if it is determined that the location determination is required for completion of the offer/task, then the verify user completed task process 160 determines if the location it of the user in proximity to the offer/task to be completed is absolutely determined. Determining the absolute location of a user in proximity to the offer/task may be completed by a means of a generic wireless position signal, a physical plug; video, audio or other analog or digital signal input which can be either directed or ambient; infrared; supervisory input by a separate human being such as a person working at the location; or other means of determining location such as for example, but not limited to requiring the user to complete a task, such as but not limited to; viewing of a video clip, completing a form or other task requiring input, performing a physical activity or entry of some form of data, such as a code or phrase word, comments, opinions, observations, or the like. The entry of data can be made by the user or be automatically received by other means. If it is determined at step 165 and that the location of the user is absolutely determined, then the verify user completed task process 160 skips to step 171.

However, it is determined at step 165 that the location of the user is not absolutely determined, then the verify user completed task process 160 determines if the user is when within a perimeter parameter of the location at step 166. This perimeter parameter defines how close the user must be to the offer/ad location to be computed as completing the location requirement. If it is determined in step 166 that the user was within the perimeter parameter location, then the verify user completed task process skips to step 171. However, if it is determined at step 166 that the user is not within the perimeter parameter location, then the verify user completed task process 160 skips to step 179 and exits.

At step 171, the verify user completed task process 160 marks the user location parameter as verified.

At step 172, the verify user completed task process 160 determines that there are more parameters to verify in order to determine that the user has completed that required tasks. If it is determined at step 172 that there are no more parameters required to verify that the user completed the required tasks, then the verify user completed task process 160 skips to step 179 to exit. However, it is determined at step 172 that there are more parameters to verify, then the next parameter in parameters of the offer/ads is verified at step 173.

At step 174, it is determined if the user completed another task defined by the offer/ad parameter. If it is determined in step 174 that the user did not complete the other parameter, then the verify user completed task process 160 skips to step 179 to exit. However, if it is determined at step 174 that the users did complete another task defined by the author/ad parameter, then the parameter is marked as verified for this user, at step 175, and then returns to repeat steps 172-179 in order to determine and verify if any other required parameters need to be met for the user to be determined as completing the required task of the offer/ad.

At step 179, the verify user completed task process 160 then exits.

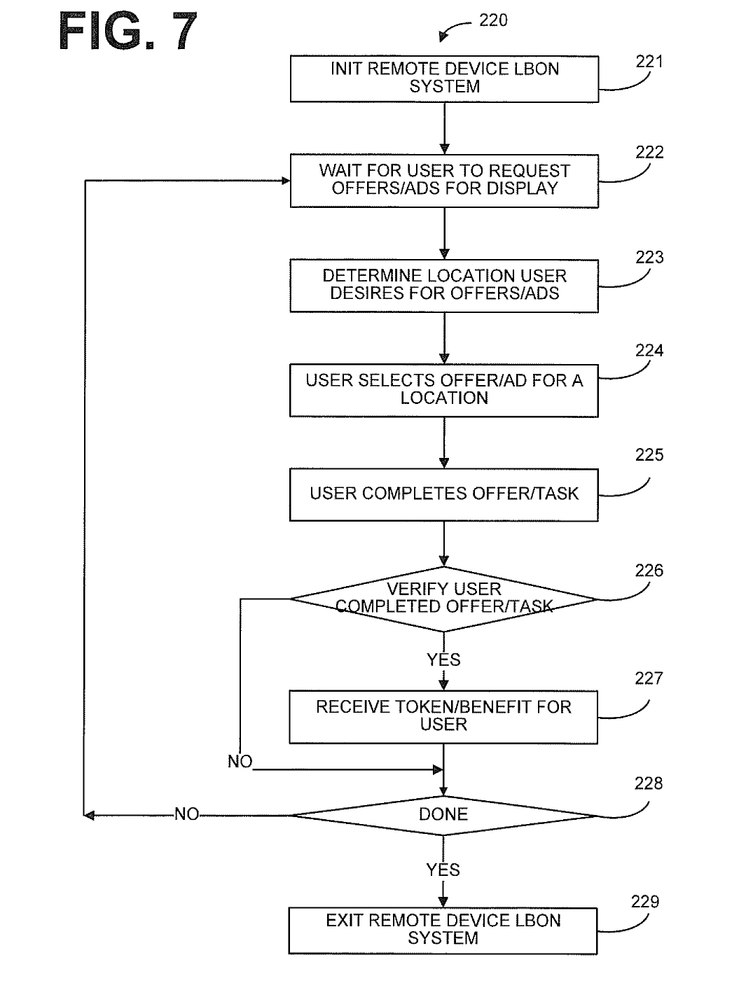

FIG. 7 is a flow chart illustrating an example of the operation of the remote device LBON system 220. The remote device LBON system 220 in one embodiment, is executed by a browser 200 on the remote device 15. The remote device LBON system 220 interacts with the location based offer network system 100 of the present invention, as shown in FIGS. 1, 2A, 3 and 5.

First at step 221, the remote device LBON system 220 in the location based offer network system 100 is initialized. This initialization includes a startup routines and processes embedded in the BIOS of the remote device 15. The initialization also includes the establishment of data values for particular data structures utilized in the remote device 15.

At step 222, the remote device LBON system 220 waits to receive an action request for displaying an offer or advertisement. Once an action request is received at step 222, the remote device LBON system 220 then determines the particular user location that the user desires for offers/advertisements at step 223. The location can be determined by using GPS, zip code, MapQuest or at there like method. The remote device LBON system 220 then transmits the selected offer the LBON system 100 on server 11 at step 224.

At step 225, the remote device LBON system 220 enables the user and the selected offers/advertisement including parameters regarding actions or tasks to be performed. The parameters include information regarding the action or task to be performed including the method to validate the action or task has been performed.

At step 226, the remote device LBON system 220 verifies that the user has completed the offer/task required to receive the token or benefit. If it is determined in step 226 that the user has not completed the offer/task in order to receive the token/benefit, then the remote device LBON system 220 skips to step 228. However, if it is determined in step 226 that the user has completed the offer/task, then the remote device LBON system 220 receives a token or benefit, at step 227, for the user for completing the offer/task at the specific location for the specific offer or advertisement selected by the user.

At step 228, the remote device LBON system 220 determines if there are more actions to be received. If it is determined in step 228 that there are more actions to be received, then the remote device LBON system 220 returns to step 222 to wait to receive the next action request. However, if it is determined in step 228 that there are no more actions to be processed, then the remote device LBON system 220 exits at step 229.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may in fact be executed substantially concurrently or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be emphasized that the above-described embodiments of the present invention, particularly any “preferred” embodiments, are merely possible examples of implementations set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method of providing an offer in a specific location embodied in a computer program product for execution on an instruction processing system, comprising a tangible storage medium readable by the instruction processing system and storing instructions for execution by the instruction processing system for performing the method comprising:
determining at least one offer to be sent to a user device;
sending the at least one offer to user device;
receiving information regarding the completion of the at least one offer;
verifying the user completed a task associated with the at least one offer; and
providing a benefit to an owner of the user device.

2. The method of claim 1, wherein the task associated with the at least one offer is being within a vicinity of a specified location.

3. The method of claim 2, wherein the vicinity of the specified location is measured by a wireless position signal.

4. The method of claim 3, wherein the wireless position signal is generated by a second device at the specific location.

5. The method of claim 2, wherein the vicinity of the specified location is determined by data input into the user device and transmitted to the instruction processing system.

6. The method of claim 2, wherein the offer is created by an advertiser that is drawing the owner of the user device into their establishment.

7. The method of claim 6, comprising:
listing the offer with parameters that identifies the task to be completed by the owner of the user device along with the benefit to the owner of the user device for completing the task.

8. The method of claim 7, wherein the parameters further include a number of times the offer can be completed.

9. The method of claim 8, wherein the parameters further include a payment for the number of times the offer can be completed.

10. The method of claim 1, wherein the offer is embedded in a game application on the Web.

11. A computer program product for providing an offer in a specific location, the computer program product comprising:
a tangible storage medium readable by a computer system and storing instructions for execution by the computer system for performing a method comprising:
determining at least one offer to be sent to a user device;
sending the at least one offer to user device;
receiving information regarding the completion of the at least one offer;
verifying the user completed a task associated with the at least one offer; and
providing a benefit to an owner of the user device.

12. The computer program product of claim 11, further comprising:
associating the task with the at least one offer is being within a vicinity of a specified location.

13. The computer program product of claim 12, further comprising:
identifying a user device in the vicinity of the specified location by a wireless position signal.

14. The computer program product of claim 13, further comprising:
generating the wireless position signal by a second device at the specific location.

15. The computer program product of claim 12, further comprising:
determining if the user device is in the vicinity of the specified location by data input into the user device and transmitted to the instruction processing system.

16. The computer program product of claim 11, wherein the offer is created by an advertiser that is tempting the owner of the user device into their establishment.

17. The computer program product of claim 11, further comprising:
listing the offer with parameters that identifies the task to be completed by the owner of the user device along with the benefit to the owner of the user device for completing the task.

18. The computer program product of claim 17, wherein the parameters further include a number of times the offer can be completed.

19. The computer program product of claim 17, wherein the parameters further include a payment for the number of times the offer can be completed.

20. The computer program product of claim 11, wherein the offer is embedded in a game application on the Web.
